(19) United States
(12) Patent Application Publication
(10) Pub. No.: US 2026/0170882 A1
(43) Pub. Date: Jun. 18, 2026

(54) SYSTEM AND METHOD FOR DETECTING A VEHICLE EVENT AND GENERATING REVIEW CRITERIA

(71) Applicant: SmartDrive Systems, Inc., Westlake, CA (US)

(72) Inventors: Jason Palmer, Carlsbad, CA (US); Slaven Sljivar, San Diego, CA (US); Mark Freitas, San Diego, CA (US); Daniel A. Deninger, Carlsbad, CA (US); Jeffrey Todd Griswold, San Diego, CA (US)

(21) Appl. No.: 18/986,098

(22) Filed: Dec. 18, 2024

(51) Int. Cl. G07C 5/00; G06Q 10/0639; G07C 5/08; G07C 5/10; G09B 5/02

(52) U.S. Cl. CPC G07C 5/008; G06Q 10/06393; G07C 5/0825; G07C 5/0866; G07C 5/10; G09B 5/02

(57) ABSTRACT

This disclosure relates to a system and method for detecting vehicle events and generating review criteria based on the detected vehicle events. Some or all of the system may be installed in a vehicle and/or be otherwise coupled with a vehicle. The system may include one or more sensors configured to generate output signals conveying information related to the vehicle and/or multiple video capture devices configured to acquire visual output information representing a vehicle environment. In some implementations, the system may determine a vehicle event type based on the information conveyed by the output signals. The system may generate review criteria, which correspond to the vehicle event, based on the vehicle event type and the fields of view corresponding to the video capture devices.

### FIELD

This disclosure relates to a system and method for detecting a vehicle event and generating review criteria that correspond to the vehicle event.

### BACKGROUND

Systems configured to record, store, and transmit video, audio, and sensor data associated with a vehicle responsive to an incident involving the vehicle are known. The video from the incident is usually analyzed by a user at a later time after the incident. Vehicle Engine Control Module (ECM) systems are known. Such systems interface with external computers (e.g., at an automobile mechanic) where the data stored by the ECM system is analyzed.

### SUMMARY

One aspect of the disclosure relates to system and method for detecting a vehicle event and generating review criteria based on the vehicle event. The system is configured to detect a vehicle event, record information representing the vehicle event, and generate review criteria relevant to the information recorded. Some or all of the system may be installed in the vehicle and/or be otherwise coupled with the vehicle. In some implementations, the system may include multiple video capture devices configured to acquire visual output information representing a vehicle environment, one or more sensors configured to generate output signals conveying vehicle operation information related to the vehicle, and/or other components. The multiple video capture devices may have one or more fields of view. The fields of view may include areas of the vehicle environment from which the multiple video capture devices are configured to acquire visual output information. The fields of view may be associated with a direction (e.g., forward looking, rear looking), a location (on top of a vehicle, on the side of a road), and/or other portions of the vehicle environment. An individual video capture device may have an individual field of view that corresponds to one or more other fields of view from other video capture devices. For example, a first field of view from a front looking video capture device and a second field of view from a video capture device positioned on the side of a road may both capture visual information related to the same vehicle event. In some implementations, the system may detect a vehicle event and record information based on the detection of a vehicle event. In some implementations, the system may determine a vehicle event type and generate review criteria based on the vehicle event type and/or fields of view corresponding to the video capture devices. In some implementations, the system may include one or more of a video capture device, a sensor, a processor, an operator interface, external resources, electronic storage, a remote computing device, a reviewer interface, and/or other components.

The video capture devices may be configured to acquire visual output information representing the vehicle environment. In some implementations, visual output information representing the vehicle environment may be acquired from system integrated and/or non-system integrated vehicle capture devices installed in the vehicle and/or the vehicle environment. The vehicle environment may include spaces in and around the interior and exterior of the vehicle. In some implementations, video capture devices may include individual cameras, a given one of the individual cameras corresponding to an individual field of view.

The sensors may be configured to generate output signals conveying vehicle operation information related to the operation and/or the context of the vehicle. Vehicle operation information related to the operation of the vehicle may include feedback information from one or more of the mechanical systems of the vehicle, one or more safety systems of the vehicle, one or more non-standard aftermarket sensors installed in the vehicle, and/or other information. In some implementations, at least one of the sensors may be a vehicle system sensor included in an ECM system of the vehicle. Information related to the context of the vehicle may include information related to the vehicle environment in and/or around the vehicle. In some implementations, the output signals conveying the vehicle operation information related to the context of the vehicle may be generated via non-standard aftermarket sensors installed in the vehicle, and/or other sensors. For example, one or more individual sensors may be and/or include a proximity sensor. Based on an analysis of the output signals from this

sensor, the system may automatically determine a person, vehicle, object and/or other objects are in proximity to the vehicle. This example sensor may be one of a plurality of sensors in the system.

One or more processors may be configured to execute one or more computer program components. The computer program components may comprise one or more of a parameter component, a detection component, a classification component, a control component, and/or other components.

The parameter component may be configured to determine one or more vehicle event parameters. The parameter component may determine the vehicle event parameters based on the information conveyed by the output signals from the sensors, visual output information acquired from the video capture devices, information acquired from external resources, and/or other information.

The detection component may be configured to detect the occurrence of the vehicle event. The detection component may be configured to detect the vehicle event in real-time or near real-time. The detection component may be configured to detect the vehicle event based on the information conveyed by the output signals generated by the sensors, the visual output information acquired by the video capture devices, information from external resources, information determined by the parameter component, and/or based on other information. For example, the vehicle event may be detected based on a comparison of the determined vehicle event parameters to predetermined vehicle event criteria.

The classification component may be configured to determine a vehicle event type for individual vehicle events. A vehicle event may have one or more vehicle event types. The classification component may determine the vehicle event type in response to the detection of the vehicle event by the vehicle detection component. In some implementations, the vehicle event type may be determined based on pre-set criteria which may be customizable for the system.

The control component may be configured to generate review criteria that correspond to the vehicle event. The review criteria may be generated based on the determined vehicle event type and the fields of view corresponding to the video capture devices. In some implementations, the control component will generate review criteria that correspond to specific fields of view and specific vehicle event types. The review criteria may be generated for a manual reviewer, for example.

The control component may be configured to facilitate wireless communication of information conveyed by the output signals, the visual output information, information related to a detected vehicle event, and/or other information to the remote computing device and/or other devices. The control component may be configured to facilitate communication responsive to the detection of the vehicle event. The control component may be configured to facilitate communication in real-time or near real-time. The control component may be configured to facilitate wireless communication of the information conveyed by the output signals, the visual output information, information related to the detected vehicle event, and/or other information from a period of time that includes at least the vehicle event.

In some implementations, the control component may be configured to facilitate recording of the vehicle event data based on detection of the vehicle event. Vehicle event data may include video, audio, ECM, metadata, GPS, and/or other sensor data for a period of time that lasts from before a given vehicle event starts until after it ends. The period of time for which data is recorded may be determined based on the timing of the vehicle event, the point in time at which the vehicle event is detected, the type of vehicle event, and/or other information.

In some implementations, the control component may be configured to selectively determine one or more types of data that are recorded based on vehicle event types and fields of view corresponding to the video capture devices. For example, the control component may selectively determine whether to record visual output information from devices having one or more specific fields of view, types of data, and/or other vehicle and/or visual output information. Continuing with the example, if the detected vehicle event involved the opening of a passenger door of the vehicle, the control component may cause a video stream from an interior camera with an interior field of view to be included in the event record for monitoring the loading and unloading of passengers. Whereas the interior field of view may not be needed when recording vehicle situations for other (non-interior) vehicle events.

In some implementations, the control component may be configured to determine how much of the event data (video, audio, sensor, etc.) to record before the vehicle event (e.g., pre-vehicle event duration) and after the vehicle event (e.g. post-vehicle event duration) based on the vehicle event itself and/or other information. This may allow the visual output information and/or vehicle operation information to reflect a relevant and/or desired time frame relative to the vehicle event.

In some implementations, the external resources may include an adaptor for adapting analog visual output information to digital visual output information. This may facilitate adapting visual output information acquired from non-system integrated video capture devices so that it has the same format as visual output information acquired from system cameras, and/or other devices. In some implementations, the adaptor may facilitate adapting one or more of a frame rate, a resolution, a brightness, a saturation, and/or an image correction of visual output information acquired from non-system integrated video capture devices.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to detect a vehicle event and generate review criteria that correspond to the vehicle event.

FIG. 2 illustrates a vehicle environment.

FIG. 3 illustrates a view of a reviewer interface.

FIG. 4 illustrates another view of a reviewer interface.

FIG. 5 illustrates another view of a reviewer interface.

FIG. 6 illustrates a method for detecting a vehicle event and generating review criteria that correspond to the vehicle event.

FIG. 7 illustrates another method for detecting a vehicle event and generating review criteria that correspond to the vehicle event.

### DETAILED DESCRIPTION

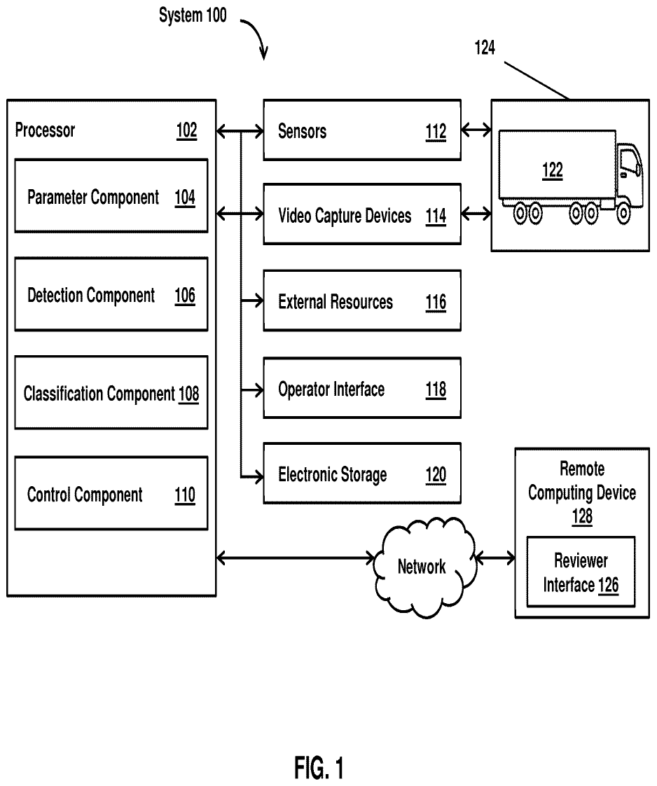

FIG. 1 illustrates a system 100 configured to detect a vehicle event and generate review criteria that correspond to the vehicle event. Some or all of system 100 may be installed in a vehicle 122 and/or be otherwise coupled with vehicle 122. System 100 may include multiple video capture devices 114 configured to acquire visual output information representing a vehicle environment 124. The individual video capture devices 114 may have separate corresponding fields of view of vehicle environment 124.

Vehicle environment 124 may include spaces in and/or around an interior and/or an exterior of vehicle 122. System 100 may include one or more sensors 112 configured to generate output signals conveying information related to the vehicle 122. In some implementations system 100 may detect the vehicle event based on the information conveyed by the output signals from sensors 112 and/or other information. System 100 may determine a vehicle event type based on information conveyed by the output signals from sensors 112, visual output information from multiple video capture devices 114, and/or other information. In some implementations, system 100 may generate review criteria that correspond to the vehicle event. The review criteria may be generated based on the vehicle event type and the fields of view corresponding to the video capture devices 114.

Review criteria may prompt a reviewer to review a vehicle event based on the vehicle event type, the fields of view corresponding to the video capture devices, and/or any other information relevant to the vehicle event. Review criteria may include questions, inquiries, prompts, and/or other review criteria related to the vehicle event. The review criteria may guide a reviewer to review relevant aspects of the vehicle event.

System 100 may be configured to monitor vehicles, equipment, drivers, operators, and/or other information to facilitate reduction of risky behaviors, facilitate coaching and/or training, mitigate damage to a vehicle, and/or for other purposes. System 100 may detect and record vehicle events and facilitate review of the vehicle events by a manual reviewer based on the review criteria. In some implementations, system 100 may determine one or more video capture devices 114 with corresponding fields of view relevant to the vehicle event detected. System 100 may generate review criteria for review by a manual reviewer based on these fields of view and/or other information.

In some implementations, system 100 may include one or more of a sensor 112, a video capture device 114, an external resource 116, an operator interface 118, electronic storage 120, a processor 102, a remote computing device 128, and/or other components.

In some implementations, one or more of the components of system 100 may form at least a portion of a vehicle event recorder system such as the vehicle event recorder system described in U.S. patent application Ser. No. 13/957,810 filed Aug. 2, 2013 entitled “Vehicle Event Recorder Systems and Networks Having Integrated Cellular Wireless Communications Systems”, which is incorporated herein by reference.

One or more video capture devices 114 may be configured to acquire visual output information representing a vehicle environment (e.g., vehicle environment 124). Video capture devices 114 may include systems for compiling and/or collecting video information, for example, video cameras, digital cameras, analog cameras, still cameras, infrared sensors, and/or other video capture devices 114 that acquire visual output information. In some implementations, video capture devices 114 may include system-integrated video capture devices, non-system integrated video capture devices (e.g., video capture devices included in external resources 116), and/or other video capture devices. Visual output information may include videos, images, clips, broadcasts, pictures, visual data and/or other visual output information representing vehicle environment 124. In some implementations, multiple video capture devices 114 may be positioned in and/or around vehicle 122 and synchronized together to provide a 360 degree view of the inside of vehicle 122 and/or a 360 degree view of the outside of vehicle 122.

In some implementations, video capture devices may be enabled and/or disabled based on user configurability, randomly determined time intervals, the detection of a vehicle event. information from one or more sensors, and or other information. For example, one or more cameras may be enabled and/or disabled based on one or more geo-fences. An individual geo-fence may be a virtual boundary line that defines, represents, and/or is otherwise related to a physical area (e.g., a storage yard where fleet vehicles are stored), a point of interest, a segment of a road/highway/etc., and/or other physical locations. Geo-fences may define areas where a particular action and/or maneuver is allowed. Geo-fences may define areas where particular driving behaviors are disallowed and/or particularly dangerous (e.g., a narrow country road). Specific geo-fences may be associated with specific vehicle events. For example, the payment of roadway tolls may be expected in a geo-fenced area near a tollbooth. In some implementations, geo-fences may be associated with a time of day. For example, a geo-fence may surround a large parking lot at a mall. The geo-fence may apply only during hours that the mall is open, and not, for example, during the early morning or late night hours. In some implementations, one or more cameras may be enabled and/or disabled based on an operator login identification information, dispatch information, and/or other information.

Although video capture devices 114 are depicted in FIG. 1 as a single element, this is not intended to be limiting. Video capture devices 114 may include one or more video capture devices located on the interior of vehicle 122, the exterior of vehicle 122, within vehicle environment 124, and/or in any location that may be in communication with the one or more processors 102 and/or other components of system 100.

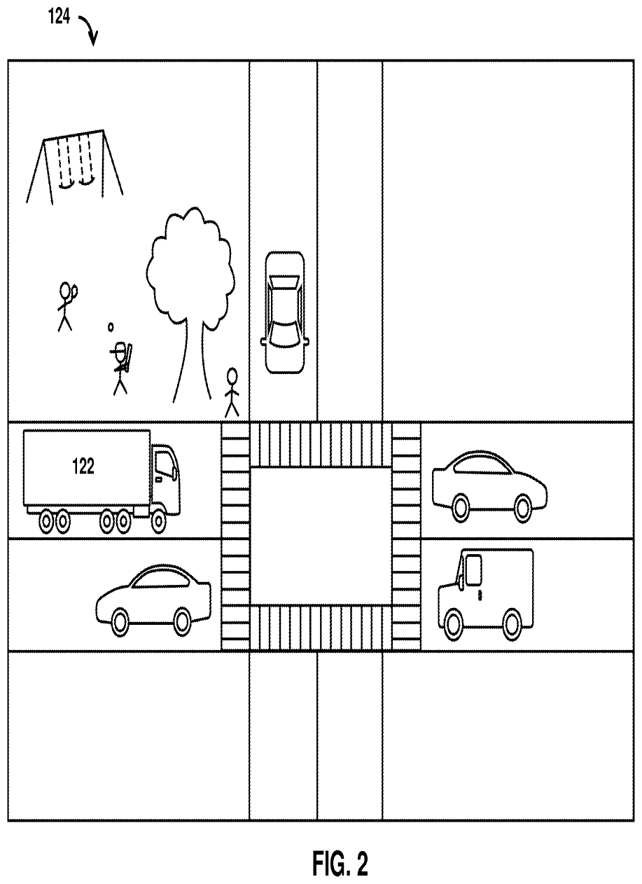

Referring to FIGS. 1-2, vehicle environment 124 may include spaces in and around the interior and/or the exterior of vehicle 122. In some implementations, vehicle environment 124 may include spaces in and/or around the interior of vehicle 122, for example, a driver space, passenger space, cargo space and/or other spaces in the interior of vehicle 122. In some implementations, vehicle environment 124 may include the spaces in and/or around the exterior of vehicle 122 such as, for example, forward space in front of vehicle 122, rear space behind vehicle 122, side space on the driver's side of vehicle 122, side space on the passenger's side of vehicle 122, aerial space above vehicle 122, and/or other spaces in or around the exterior of vehicle 122.

Individual ones of the one or more video capture devices 114 may have separate corresponding fields of view of the vehicle environment 124. In some implementations, the separate corresponding fields of view may include, for example, one or more of a forward view, a rear view, a passenger's side view, a driver's side view, a driver view, a cargo view, a left view, a right view, and/or other suitable corresponding fields of view.

One or more sensors 112 may be configured to generate output signals conveying information related to the operation and/or the context of vehicle 122. Information related to the operation of vehicle 122 may include feedback information from one or more of the mechanical systems of vehicle 122, one or more non-standard aftermarket sensors 112 coupled with vehicle 122, and/or other feedback information from other sensors. The mechanical systems of vehicle 122 may include, for example, the engine, the drive train, the lighting systems (e.g., headlights, brake lights), the braking system, the transmission, fuel delivery systems, door/compartment locking systems and/or other mechanical systems. The mechanical systems of vehicle 122 may include one or more mechanical sensors, electronic sensors, and/or other sensors that generate the output signals (e.g., seat belt sensors, tire pressure sensors, etc.).

In some implementations, at least one of sensors 112 may be a vehicle system sensor included in an ECM system of vehicle 122. For example, in some implementations, system 100 may be configured such that a first sensor 112 may be a fuel level sensor which may be associated with an ECM system of vehicle 122. In some implementations, non-standard aftermarket sensors 112 may be coupled with vehicle 122 such that they generate output signals that convey information related to the mechanical systems of vehicle 122. For example, a non-standard aftermarket sensor 112 may be configured to generate output signals that convey information related to braking force. Information related to the context of vehicle 122 may include information related to vehicle 122 relative to the vehicle environment 124. The information related to the context of vehicle 122 may include information related to movement of vehicle 122 (e.g., acceleration, velocity, etc.), an orientation of vehicle 122, a geographic position of vehicle 122, a spatial position of vehicle 122 relative to other objects, a tilt angle of vehicle 122, an inclination/declination angle of vehicle 122, other objects or persons in proximity to vehicle 122, weather conditions surrounding vehicle 122, and/or other information. In some implementations, the output signals conveying the information related to the context of vehicle 122 may be generated via non-standard aftermarket sensors installed in vehicle 122, and/or other sensors. The non-standard aftermarket sensor may include, for example, a video camera (e.g., a video capture device 114), a microphone, an accelerometer, a gyroscope, a geolocation sensor (e.g., a GPS device), a magnetometer, radar (e.g. for measuring distance of leading vehicle), a temperature sensor, a light sensor, and/or other sensors.

Although sensors 112 are depicted in FIG. 1 as a single element, this is not intended to be limiting. Sensors 112 may include one or more sensors located adjacent to and/or in communication with the various mechanical systems of vehicle 122, in one or more positions (e.g., at or near the front of vehicle 122) to accurately acquire information representing the vehicle environment (e.g. visual information, spatial information, orientation information), and/or in other locations. For example, in some implementations, system 100 may be configured such that a first sensor located on top of vehicle 122 is in communication with a geolocation satellite, and a second sensor is located near the operator of vehicle 122 and configured to generate output signals conveying information related to the actions and/or behavior of the operator of vehicle 122. In some implementations, sensors 112 may be configured to generate output signals continuously and/or at intervals during operation of vehicle 122.

Although video capture devices 114 and sensors 112 are depicted in FIG. 1 as separate elements, this is not intended to be limiting. In some implementations, video capture devices 114 may include sensors 112 and/or sensors 112 may include video capture devices 114.

As shown in FIG. 1, processor 102 may be configured to execute one or more computer program components. The computer program components may comprise one or more of a parameter component 104, a detection component 106, a classification component 108, a control component 110, and/or other components.

In some implementations, control component 110 may be configured to associate the visual output information from multiple video capture devices 114, the vehicle operation information conveyed by the output signals of the one or more sensors 112, the vehicle event type, the vehicle event data, the review criteria, and/or the information from any external resources 116, with information related to operation and/or context of the vehicle that corresponds to a given vehicle event into a vehicle event record for that vehicle event.

Parameter component 104 may be configured to determine one or more vehicle event parameters of vehicle 122. Parameter component 104 may determine the vehicle event parameters based on the information conveyed by the output signals from sensors 112, the visual output information acquired by the video capture devices 114, information provided by external systems and/or databases, and/or other information. The one or more vehicle event parameters may be related to the operation of vehicle 122, the context of vehicle 122, vehicle environment 124, and/or other information. For example, the one or more vehicle event parameters may be related to one or more of an acceleration, a direction of travel, a vehicle speed, an engine speed (e.g. RPM), a duration of time, a closing distance, a lane departure from an intended travelling lane of the vehicle, a following distance, the proximity of another car or person to vehicle 122, the opening of a door or compartment of vehicle 122, the arrival of vehicle 122 at a specific destination, and/or other parameters. Vehicle event parameters may have associated predetermined criteria.

Detection component 106 may be configured to detect a vehicle event. Detection of a vehicle event may be based on the information conveyed by the output signals from the one or more sensors 112, the visual output information from the multiple video capture devices 114, parameters determined by parameter component 104, and/or other sources of vehicle operation information. Detection component 106 may detect a vehicle event in real-time, near-real time, and/or other time. In some implementations, vehicle events may have associated predetermined detection criteria. The detection of a vehicle event may be based on one or more determined vehicle event parameters satisfying predetermined criteria. In some implementations, a vehicle event may be detected based on, for example, information, output signals, determined parameters, and/or other information related to one or more of acceleration or deceleration, a direction of travel, a vehicle speed, an engine speed (e.g. RPM), a duration of time, a closing distance, a lane departure, a following distance, another vehicle in close proximity, a person in close proximity, an open door or compartment, a geolocation, a collision, an assault on the operator of vehicle 122, the loading and unloading of cargo from and onto vehicle 122, a passenger incident, property theft, damage to vehicle 122, operator engagement in unsafe or non-compliant activities, fare payments, a video capture device trigger, and/or other vehicle events related to vehicle 122. For example, the detection of a vehicle event such as backing may be based on a video capture device that detects backing presenting and/or capturing visual output information. In some implementations, a vehicle event may include external events not related to vehicle 122. For example, an external event may include an explosion at a job site located within one or more fields of view corresponding to one or more video capture devices of vehicle 122.

In some implementations, detection component 106 may be configured to detect a vehicle event based on output signals from one or more sensors 112 remotely triggered by a user and/or operator. A user and/or operator may remotely trigger one or more of sensors 112 to output information detected by detection component 106 indicating a vehicle event. For example, if a user and/or operator notice something amiss, the user and/or operator may use a remote push bottom to wirelessly trigger one or more sensors to indicate a vehicle event and record visual output information from one or more video capture devices.

By way of a first non-limiting example, detection component 106 may be configured to detect a vehicle event such as the arrival of vehicle 122 at a designated geolocation based on the output signals from a geolocation sensor 112. Detection component 106 may be configured to detect the arrival of vehicle 122 at a designated geolocation in order to monitor a situation such as the payment of fares. Detection component 106 may detect the arrival of vehicle 122 at a designated geolocation based on geolocation parameters determined by parameter component 104 satisfying predetermined geolocation criteria.

By way of a second non-limiting example, detection component 106 may be configured to detect a vehicle event such as a departure from the intended vehicle lane to monitor a potential situation such as a collision.

By way of a third non-limiting example, detection component 106 may be configured to detect a vehicle event such as the opening of a door and/or compartment of vehicle 122 to monitor the loading or unloading of cargo and/or passengers.

By way of a forth non-limiting example, detection component 106 may be configured to detect a vehicle event such as the opening of a cargo compartment and/or motion within a cargo compartment while vehicle 122 is not located at a designated delivery location to monitor a possible situation such as theft.

Classification component 108 may be configured to determine a vehicle event type based on the information conveyed by the output signals from one or more sensors 112, the visual output information from multiple video capture devices 114, information determined by parameter component 104, information determined by detection component 106, information from external resources 116, and/or other information. In some implementations, determining the vehicle event type may include classification of the vehicle event into one or more vehicle event type categories. In some implementations, for example, the vehicle event type may be one or more of a rear vehicle event type, a front vehicle event type, a side vehicle event type, an interior vehicle event type, an exterior vehicle event type, a damage vehicle event type, a fare vehicle event type, a loading/unloading vehicle event type, an operator vehicle event type, and/or other vehicle event types. In some implementations, vehicle event types may be customizable and/or determined by a user. The user may include the operator, reviewer, and/or other users. The user may customize the vehicle event types, for example, a user may determine the vehicle event types include front vehicle events, rear vehicle events, side vehicle events, and/or other vehicle events determined by the user. In some implementations, a vehicle event type may be based on visual output information being available from one or more non-system video capture devices and/or other external resources 116.

Control component 110 may be configured to trigger vehicle event recording (e.g., recording of visual output information and/or other sensor information associated with a vehicle event) based on vehicle event detection. Visual output information and/or sensor information may include video, audio, ECM, metadata, and/or other sensor data for a period of time that lasts from before a given vehicle event starts until after it ends. The period of time for which data is recorded may be determined based on the timing of the vehicle event, the point in time at which the vehicle event is detected, and/or other information. Control component 110 may be configured to trigger recording of substantially all vehicle event data (e.g., video, audio, sensor output signals, etc.), and not just the signals, visual output information, and/or parameters used for vehicle event detection. In some implementations, control component 110 may be configured to trigger recording of visual output information from individual ones of the one or more video capture devices that may have acquired visual output information relevant to the detected vehicle event based on its corresponding field of view and/or the vehicle operation information conveyed by the output signals from sensors 112.

Control component 110 may be configured such that the visual output information and/or vehicle operation information is saved to a non-volatile memory (e.g., included in electronic storage 120) and later offloaded wirelessly via a vehicle event recorder system such as the vehicle event recorder system described in U.S. patent application Ser. No. 11/377,167 filed Mar. 16, 2006 and entitled, “Vehicle Event Recorder Systems And Networks Having Integrated Cellular Wireless Communications Systems” (incorporated by reference above), and/or the vehicle event recorder system described in U.S. patent application Ser. No. 11/377,157 filed Mar. 16, 2006 and entitled, “Vehicle Event Recorder Systems and Networks Having Parallel Communications Links,” which is incorporated herein by reference.

Control component 110 may be configured to generate review criteria corresponding to the vehicle event. The generation of review criteria may be responsive to the detection of the vehicle event by detection component 106. Review criteria may be generated based on the vehicle event type, fields of view corresponding to the video capture devices 114, and/or other information. Control component 110 may determine which video capture devices 114 may have acquired visual output information relevant to the detected vehicle event based on their corresponding fields of view. Control component 110 may generate review criteria for the visual output information acquired by these individual video capture devices 114. In some implementations, the review criteria for a first individual field of view corresponding to a first individual video capture device 114 may be different than the review criteria for a second individual field of view corresponding to a second individual video capture device 114.

By way of a first non-limiting example, review criteria generated for a rear field of view may be different than review criteria generated based on a driver field of view.

By way of a second non-limiting example, review criteria generated based on an exterior vehicle event type may be different than review criteria based on an interior vehicle event type.

By way of a third non-limiting example, review criteria generated based on an exterior vehicle event type and the field of view corresponding to a rear video capture device may be different from review criteria generated based on an interior vehicle event type and the field of view corresponding to a rear video capture device, which may be further different from review criteria generated based on an exterior vehicle event type and the field of view corresponding to a front video capture device.

Control component 110 may be configured to facilitate wireless communication of vehicle operation information, the visual output information, the vehicle event detection information, the vehicle event type, the vehicle event data, the review criteria, and/or other information to remote computing device 128 and/or other devices. In some implementations, control component 110 may be configured to facilitate wireless communication of visual output information as a live feed to a wireless handheld device.

Control component 110 may be configured to facilitate communication responsive to the detection of a vehicle event. Control component 110 may be configured to facilitate communication, in real-time, near-real time, and/or other time, of individual visual output information from individual video output devices. The individual visual output information communicated, the timing of the communication, and/or other characteristics of the wireless communication may be based on one or more of the vehicle event type, an intensity, the one or more fields of view available, and/or other information. The one or more fields of view available may be based on the determination of which video capture devices 114 are enabled and/or may have acquired visual output information relevant to the detected vehicle event based on their corresponding fields of view. By way of non-limiting example, visual output information from a video capture device having a rear field of view may be communicated if the vehicle event type is a rear collision.

Control component 110 may be configured to facilitate communication in real time, near real-time, and/or other time. For example, control component 110 may facilitate one or more individual communications during the operation of vehicle 122. Each individual communication may be responsive to a detected vehicle event and/or may occur just after detection of a vehicle event. In some implementations, control component 110 may be configured to facilitate communication after use of vehicle 110 has ceased such that the vehicle operation information, visual output information, information identifying the vehicle event detected by detection component 106, the vehicle event type, the vehicle event data, the review criteria, and/or other information is communicated in a single communication and/or multiple communications.

Control component 110 may be configured to facilitate storage and/or wireless communication of the vehicle operation information conveyed by the output signals, the visual output information, the information identifying the vehicle event detected by detection component 106, the vehicle event type, the vehicle event data, the review criteria, information from any external resources 116, and/or other information from a period of time that includes at least the vehicle event. For example, control component 110 may facilitate communication and/or storage of the information conveyed by the output signals, the visual output information, and/or other information from a period of time that begins before the beginning of the detected vehicle event, lasts throughout the vehicle event, and ends after the end of the detected vehicle event. Control component 110 may be configured such that the period of time that includes at least the vehicle event is centered around the specific vehicle event and includes a pre-vehicle event time, the vehicle event, and a post-vehicle event time, wherein the pre-vehicle event time and the post vehicle event time are approximately equal. In some implementations, control component 110 may be configured such that the period of time that includes at least the vehicle event begins with the vehicle event and continues for a post-vehicle event period of time.

In some implementations, control component 110 may be configured to determine how much of the vehicle event data (video, audio, sensor, etc.) to record before the vehicle event (e.g., pre-vehicle event duration) and after the vehicle event (e.g. post-vehicle event) based on the vehicle event itself. This may allow the event data to show a relevant and/or desired time frame.

For example, responsive to detection of the opening of a passenger door by detection component 106, control component 110 may be configured to facilitate wireless communication and/or electronic storage of the vehicle operation information conveyed by the output signals, the visual output information, the vehicle event type, the vehicle event data, the review criteria, and/or other information. The communicated and/or stored information may include, for example, video images showing the operator performing the vehicle event, video images before the performance of the vehicle event, video images after the performance of the vehicle event, the vehicle event type, the corresponding fields of view of video capture devices 114, and/or other information.

In some implementations, control component 110 may be configured to facilitate temporary electronic storage of the vehicle information conveyed by the output signals, the visual output information, the vehicle event type, the corresponding fields of view or the video capture devices and/or other information in electronic storage (as described above). Control component 110 may be configured to facilitate temporary electronic storage until the information is communicated to remote computing device 128. Control component 110 may be configured to erase the data temporarily stored in electronic storage 120 responsive to the communication to remote computing device 128.

In some implementations, control component 110 may be configured to cause one or more sensors 112 and/or one or more video capture devices 114 to operate continuously. For example, control component 110 may cause a video camera (e.g., video capture device 114) to continuously generate video images (e.g., visual output information. of vehicle 122, the vehicle environment 124, and/or other vehicle information. Control component 110 may be configured to cause system 100 to continuously buffer visual output information and vehicle operation information which may include, for example, video, audio, sensor, and/or other information. Control component 110 may be configured such that once the vehicle event occurs, the buffered data related to the vehicle event is transferred from a volatile to a non-volatile memory. Control component 110 is configured such that a determination is made in real-time as to whether or not the data related to the vehicle event should be offloaded immediately or kept on the device as backup.

In some implementations, control component 110 may facilitate display of a customizable reviewer interface 126. For example, customizable reviewer interface 126 may facilitate review of the vehicle events by a manual reviewer based on the review criteria. Customizable reviewer interface 126 may include multiple views and may display a portion of the vehicle operation information a portion of the visual output information, and/or other information. The display of the portion of the visual output information may include display of individual ones of the fields of view corresponding to the video capture devices 114. In some implementations, control component 110 may be configured to automatically determine a quantity, the corresponding fields of view, and/or location of visual output information that appears in the customizable reviewer interface. For example, control component 110 may dynamically configure video streams (e.g., visual output information) in groups of two or more. Labeling and/or mapping of visual output information from one or more fields of view may be user configurable.

In some implementations, vehicle operation information and/or visual output information may be routed to one or more given manual reviewers based on a given vehicle event, vehicle event type, information source, information type, and/or other characteristics of the vehicle operation information and/or visual output information. For example, vehicle operation information and/or visual output information corresponding to a rear vehicle event type may be routed to one or more of a set of manual reviewers trained to analyze and/or review vehicle events of the rear vehicle event type. In some implementations, review of vehicle operation information and/or visual output information may be prioritized based on a portion of the vehicle operation information, a portion of the visual output information, a vehicle event type, and/or other characteristics of the vehicle event and/or information.

In some implementations, control component 110 may be configured to synchronize visual output information from one or more video output devices (e.g., synchronize multiple sets of video streams together). For example, visual output information may be synchronized via a field programmable gate arrays located in one or more of video capture devices 114, external resources 116, and/or other locations.

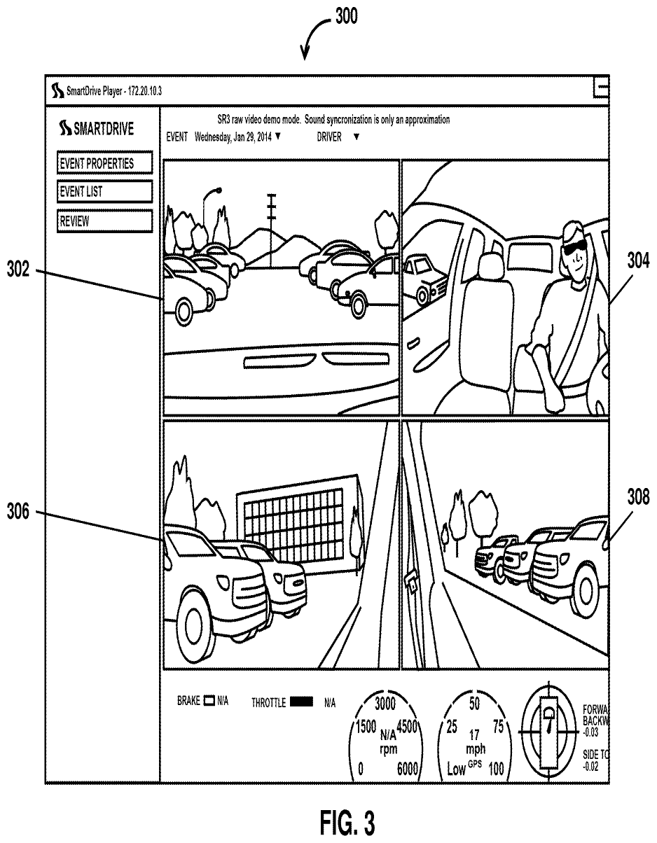

Referring to FIG. 3, in some implementations, customizable reviewer interface 126 may include a view 300. View 300 may have one or more fields including fields 302, 304, 306, and 308 which may display the visual output information from individual ones of the fields of view corresponding to the video capture devices 114. In some implementations, the manual reviewer can choose to display a specific field of view corresponding to a specific video capture device in each of fields 302, 304, 306, and 308. In some implementations, view 300 may have one or more fields which may display review criteria for the visual output information displayed in any one or more of fields 302, 304, 306, or 308, based on the individual ones of the fields of view.

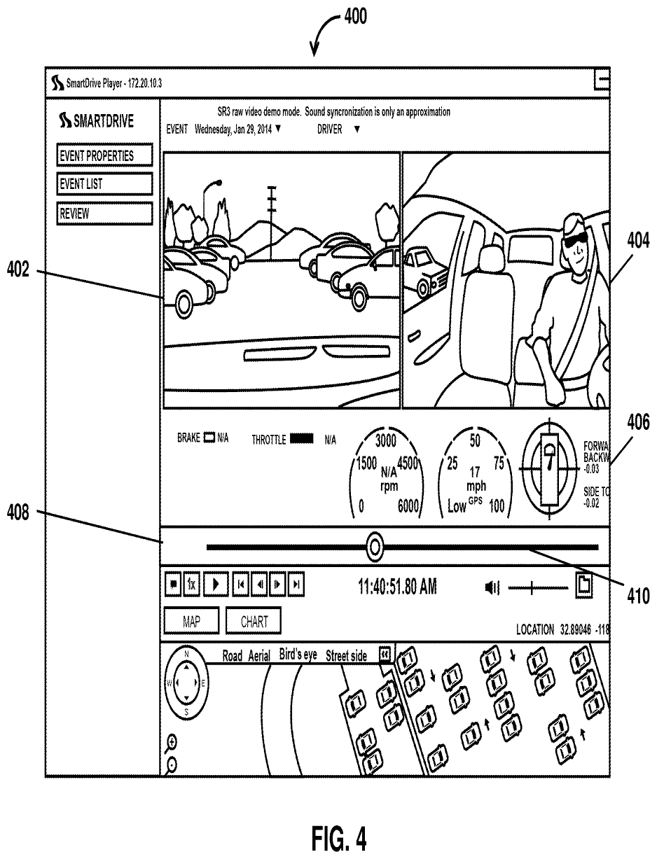

Referring to FIG. 4, in some implementations, customizable reviewer interface 126 may include a view 400. View 400 may have one or more fields including fields 402 and 404 which may display the visual output information from individual ones of the fields of view corresponding to the video capture devices 114. In some implementations, view 400 may have one or more fields which may display review criteria for the visual output information displayed in any or both of fields 402 or 404, based on the individual ones of the fields of view. In some implementations, view 400 may include a field 406 which may display a portion of the vehicle operation information generated from the output signals from one or more sensors 112. In some implementations, view 400 may include field 408 which may display a timeline 410 corresponding to the time at which the displayed vehicle operation information and/or visual output information was acquired and/or conveyed.

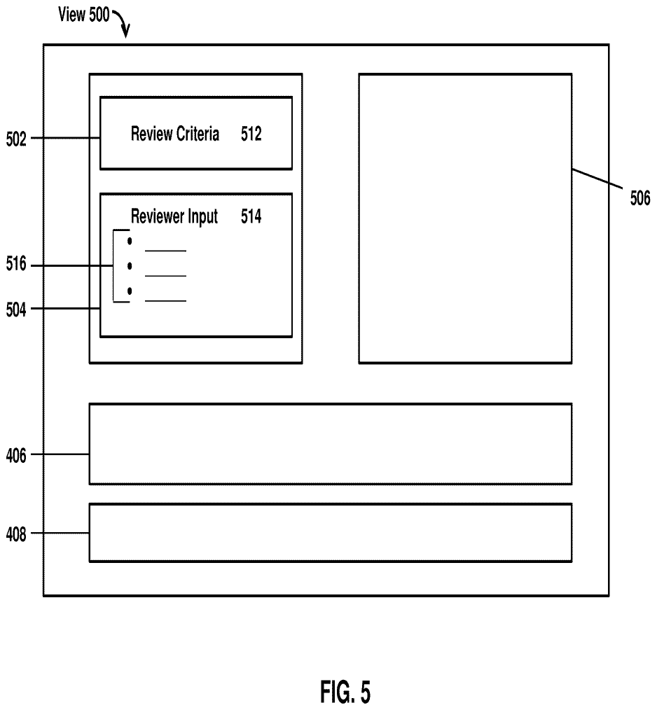

Referring to FIG. 5, in some implementations, customizable reviewer interface 126 may include a view 500. View 500 may have one or more fields including field 502 which may display the review criteria 512 generated by control component 110. View 500 may include an input field 504 which may display reviewer input 514 including graphical control elements to accept reviewer selections and/or input based on the review criteria 512. The graphical control elements 516 may include, for example, one or more of a button, text field, checkbox, radio button, dropdown list, list box, slider, toggle, and/or other graphical control elements 516. View 500 may include field 506 which may display the visual output information from an individual field of view corresponding to a video capture device 114.

Returning to FIG. 1, in some implementations, control component 110 may be configured to generate coaching session information that corresponds to the vehicle event for use in a coaching session. The generation of coaching session information may be generated responsive to an entry and/or selection of information during a review of the vehicle event and/or previous vehicle events of the same and/or similar vehicle event type by a manual reviewer. By way of a first non-limiting example, to provide a coaching session for proper loading and unloading of passengers, coaching session information corresponding to the vehicle event, such as the opening of a passenger door of vehicle 122, and/or previous vehicle events of the same vehicle event type, such as an interior vehicle event type, may be generated for use in a coaching session.

In some implementations, users (e.g., customers) may indicate preferences such that system 100 prioritizes individual vehicle event types. Control component 110 may be configured to include a feedback mechanism for users to rate events and receive more or less events of a given vehicle event type via reviewer interface 126, operator interface 118, and/or another interface.

In some implementations, control component 110 may be configured to alert a user if one or more video capture devices are plugged-in, enabled, and/or functioning based on the user configuration.

In some implementations, control component 110 may generate a performance score for a vehicle operator of vehicle 122 at the time of the vehicle event. The performance score may be generated based on information received and/or selected during a manual review of the specific vehicle event facilitated by the review criteria. In some implementations, the performance score may be normalized based on the one or more fields of view corresponding to the video capture devices 114 that acquire visual output information relevant to the specific vehicle event. In some implementations, the performance scores from multiple vehicle events may be averaged or combined to generate an overall performance score. In some implementations, the vehicle operation information, visual output data, and/or information from any external resources, may be associated with the generated performance score in a given event record. The associated vehicle operation information, visual output data, and/or information from any external resources 116, may be compiled and/or filtered based on the generated performance scores for use in a coaching session.

Returning to FIG. 1, system 100 may include multiple video capture devices 114 configured to acquire visual output information representing vehicle environment 124. The visual output information may include one or more given visual output information. A given visual output information may have a digital format and/or an analog format. In some implementations, the given visual output information may be acquired from system integrated video capture devices 114 and/or non-system integrated video capture devices (e.g., external resources 116). Non-system integrated video capture devices may be located on the exterior and/or interior of vehicle 122, in vehicle environment 124, and/or other locations. In some implementations, system 100 includes external resources 116 such as an adapter. External resources 116 may include one or more of an adaptor and/or multiple resources that combine to create an adaptor. The adaptor may be configured to convert analog information to digital information. In some implementations, the adaptor of system 100 may convert a given visual output information having the analog format to a given visual output information having a digital format. The adaptor of system 100 may properly terminate video cables and/or other cables from video capture devices 114. In some implementations, termination of visual output information may be configurable.

In some implementations, the adapter of system 100 may control and/or adapt one or more of a frame rate, a resolution, a brightness, a contrast, a saturation, an image correction, and/or other characteristics of a given visual output information which may be acquired from one or more non-system integrated video capture devices (e.g., external resources 116). By way of non-limiting example, the adaptor of system 100 may be configured to control and/or adapt characteristics of visual output information based on a vehicle event type.

In some implementations, external devices 116 may include a connection device and/or media hub (e.g., a registered jack). The connection device may include strain relief features and/or environment protection features (e.g., IP67).

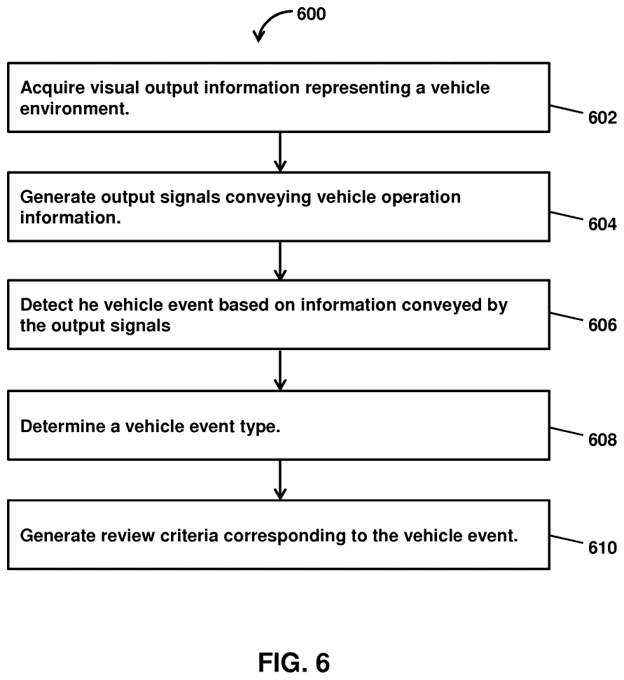

FIG. 6 illustrates method 600 for detecting a vehicle event and generating review criteria that may correspond to the vehicle event. The operations of method 600 presented below are intended to be illustrative. In some implementations, method 600 may be accomplished with one or more additional operations not described, and/or without one or more of the operations discussed. Additionally, the order in which the operations of method 600 are illustrated (in FIG. 6) and described below is not intended to be limiting. In some implementations, two or more of the operations may occur substantially simultaneously.

In some implementations, method 600 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 600 in response to instructions stored electronically on one or more electronic storage mediums. The one or more processing devices may include one or more devices configured through hardware, firmware, and/or software to be specifically designed for execution of one or more of the operations of method 600.

Referring to FIG. 6 and method 600, at an operation 602, visual output information representing the vehicle environment and/or other visual output information, may be acquired from individual video capture devices which may have separate corresponding fields of view of the vehicle environment. The vehicle environment may include spaces in and around the interior and exterior of the vehicle and/or other spaces. The separate corresponding fields of view may include, for example, one or more of a forward view, a rear view, a passenger's side view, a driver's side view, a driver view, a cargo view, a left view, a right view, and/or other suitable corresponding fields of view. In some implementations, acquiring visual output information from individual video capture devices may include acquiring visual output information from individual system video capture devices and or individual non-system integrated capture devices. Operation 602 may be performed by one or more video capture devices similar to/or the same as video capture devices 114 (shown in FIG. 1 and described herein.)

At an operation 604, output signals conveying vehicle operation information related to the operation and/or context of the vehicle may be generated by one or more sensors. The vehicle operation information conveyed by the output signals may be related to one or more of mechanical systems of the vehicle, movement of the vehicle, an orientation of the vehicle, a geographic position of the vehicle, a spatial position of the vehicle relative to other objects, and/or other operational/contextual characteristics of the vehicle. In some implementations, the sensors may include a camera and the output signals may include visual output information. In some implementations, the output signals may convey information related to mechanical systems of the vehicle. The output signals conveying information related to mechanical systems of the vehicle may be generated by one or more vehicle subsystem sensors included in a vehicle on board data system. In some implementations, operation 604 may be performed by one or more sensors the same as or similar to sensors 112 (shown in FIG. 1 and described herein).

At an operation 606, a vehicle event may be detected based on information conveyed by the output signals, and/or other information. In some implementations, the vehicle event may be detected based on, for example, information or signals related to one or more of acceleration and/or deceleration, a direction of travel, a vehicle speed, an engine speed (e.g. RPM), a duration of time, a closing distance, a lane departure, a following distance, another vehicle in close proximity, a person in close proximity, an open door or compartment, a geolocation, and/or other vehicle events of vehicle. The detection may be in real-time or near real-time. The detection may be based on the information conveyed by the output signals from the one or more sensors, the visual output information from multiple video capture devices, and/or other information. In some implementations, a set of parameters may describe the vehicle event and the vehicle event may be detected based on those parameters. In some implementations, operation 606 may be performed by a processor component the same as or similar to detection component 106 (shown in FIG. 1 and described herein).

In some implementations, operation 606 may include wireless communication of the vehicle operation information and/or the visual output information. The facilitation of the wireless communication may be in real-time, near real-time, and/or other time. The facilitation of the wireless communication may be responsive to the detection of the vehicle event. The vehicle operation information and the visual output information that is wirelessly communicated may include information for a period of time that may include the vehicle event and/or other information. The information may include, for example, video and/or other data associated with a vehicle event and/or the vehicle environment. In some implementations, operation 606 may be performed by a processor component the same as or similar to control component 110 (shown in FIG. 1 and described herein).

In some implementations, operation 606 may include electronic storage of the vehicle operation information and/or the visual output information. Facilitation of the electronic storage may be responsive to the detection of the vehicle event. The electronically stored information may include the information for the period of time that may include the vehicle event and/or other information. In some implementations, operation 606 may be performed by a processor component and/or electronic storage the same as or similar to control component 110 and/or electronic storage 118 (shown in FIG. 1 and described herein).

At an operation 608, a vehicle event type may be determined based on the vehicle operation information conveyed by the output signals, the visual output information from multiple video capture devices, information from external resources, and/or other information. The determination of a vehicle event type may be responsive to the detection of the vehicle event. In some implementations, the vehicle event type may be determined based on visual output information that may be acquired from multiple video capture devices. The video capture devices may have individual corresponding fields of view. In some implementations, the vehicle event type may be determined based on information conveyed by the individual corresponding fields of view of the video capture devices. The vehicle event type may include more than one vehicle event type and/or one or more vehicle event subtypes. Operation 608 may be performed by a processor component the same as or similar to classification component 108 (shown in FIG. 1 and described herein.)

At an operation 610, review criteria may be generated that correspond to the vehicle event. The review criteria may be based on the vehicle event type, the fields of view corresponding to the video capture devices, and/or other information. In some implementations, at operation 610, it may be determined which video capture devices may have acquired visual output information relevant to the detected vehicle event based on their corresponding fields of view. Review criteria may be generated for the visual output information acquired by these individual video capture devices 114. For example, review criteria generated for a rear view may be different that review criteria generated for a side view. In some implementations, the review criteria may be generated based on corresponding fields of view of non-system integrated video capture devices. Non-system integrated video capture devices may be located, for example, in the vehicle environment, on the vehicle, on other vehicles, and/or other locations. Operation 610 may be performed by a processor component similar to/or the same as control component 110 (shown in FIG. 1 and described herein.)

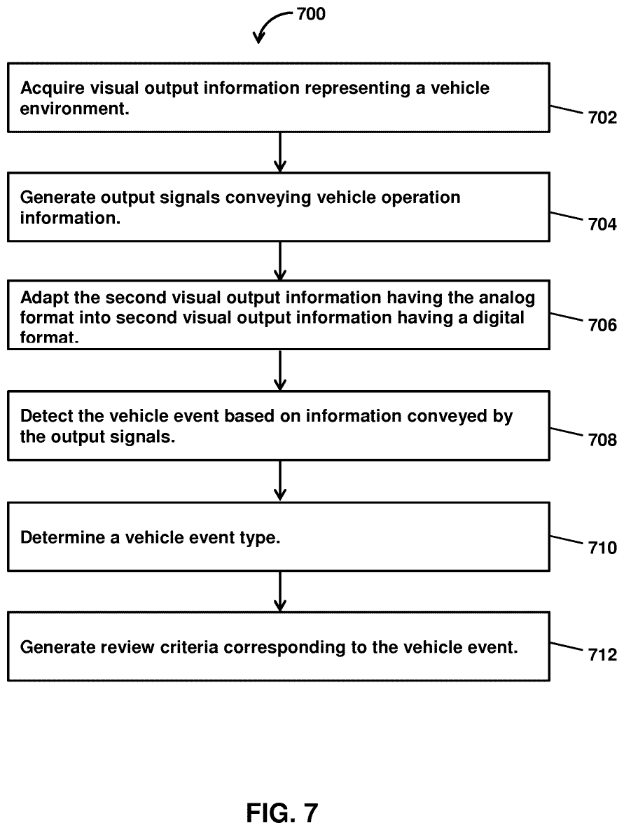

FIG. 7 illustrates method 700 for detecting a vehicle event and generating review criteria 502 that may correspond to the vehicle event. The operations of method 700 presented below are intended to be illustrative. In some implementations, method 700 may be accomplished with one or more additional operations not described, and/or without one or more of the operations discussed. Additionally, the order in which the operations of method 700 are illustrated (in FIG. 7) and described below is not intended to be limiting. In some implementations, two or more of the operations may occur substantially simultaneously.

In some implementations, method 700 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 700 in response to instructions stored electronically on one or more electronic storage mediums. The one or more processing devices may include one or more devices configured through hardware, firmware, and/or software to be specifically designed for execution of one or more of the operations of method 700.

Referring to FIG. 7 and method 700, at an operation 702, visual output information representing a vehicle environment and/or other visual output information, may be acquired from individual video capture devices which may have separate corresponding fields of view of the vehicle environment. The vehicle environment may include spaces in and around the interior and exterior of the vehicle and/or other spaces. The separate corresponding fields of view include, for example, one or more of a forward view, a rear view, a passenger's side view, a driver's side view, a driver view, a cargo view, a left view, a right view, and/or other suitable corresponding fields of view. The visual output information may include one or more given visual output information. The given visual output information may have a digital format and/or an analog format. In some implementations, a given visual output information having an analog format may be acquired from non-system integrated video capture devices and/or system integrated video capture devices. Operation 702 may be performed by one or more video capture devices similar to/or the same as video capture devices 114 (shown in FIG. 1 and described herein.)

At an operation 704, output signals conveying vehicle operation information related to the operation and/or context of the vehicle may be generated by one or more sensors. The vehicle operation information conveyed by the output signals may be related to one or more of mechanical systems of the vehicle, movement of the vehicle, an orientation of the vehicle, a geographic position of the vehicle, a spatial position of the vehicle relative to other objects, and/or other operational/contextual characteristics of the vehicle. In some implementations, the sensors may include a camera and the output signals may include visual output information. In some implementations, the output signals may convey information related to mechanical systems of the vehicle. The output signals conveying information related to mechanical systems of the vehicle may be generated by one or more vehicle subsystem sensors included in a vehicle on board data system. In some implementations, operation 704 may be performed by one or more sensors the same as or similar to sensors 112 (shown in FIG. 1 and described herein).

At operation 706, the given visual output information having an analog format may be adapted into a given visual output having a digital format. An adapted given visual output and a non-adapted given visual output may then have the same format. In some implementations, one or more given visual outputs may be converged onto a timeline. The timeline may present the visual output information according to when it was acquired. In some implementations, operation 706 may be performed by one or more external resources the same as or similar to external resources 116 (shown in FIG. 1 and described herein).

At an operation 708, a vehicle event may be detected based on information conveyed by the output signals. In some implementations, the vehicle event may include, for example, information or signals related to one or more of acceleration or deceleration, a direction of travel, a vehicle speed, an engine speed (e.g. RPM), a duration of time, a closing distance, a lane departure, a following distance, another vehicle in close proximity, a person in close proximity, an open door or compartment, a geolocation, and/or other vehicle events of vehicle. The detection may be in real-time or near real-time. The detection may be based on the information conveyed by the output signals from the one or more sensors, the visual output information from multiple video capture devices, and/or other information. In some implementations, the vehicle event may have associated predetermined criteria. The detection of the vehicle event may be based on one or more determined vehicle event parameters satisfying predetermined criteria. In some implementations, operation 708 may be performed by a processor component the same as or similar to detection component 106 (shown in FIG. 1 and described herein).

At an operation 708, wireless communication of the vehicle operation information and the visual output information may be facilitated. The facilitation of the wireless communication may be in real-time or near real-time. The facilitation of the wireless communication may be responsive to the detection of the vehicle event.

The vehicle operation information and/or the visual output information that is wirelessly communicated may include information for a period of time that may include the vehicle event and/or other information. The information may include, for example, video and/or other data associated with a vehicle event and/or the vehicle surroundings. In some implementations, operation 708 may be performed by a processor component the same as or similar to control component 110 (shown in FIG. 1 and described herein).

At an operation 708, electronic storage of the vehicle operation information and/or the visual output information may be facilitated. Facilitation of the electronic storage may be responsive to the detection of the vehicle event. The electronically stored information may include the information for the period of time that may include the vehicle event and/or other information. In some implementations, operation 708 may be performed by a processor component and/or electronic storage the same as or similar to control component 110 and/or electronic storage 118 (shown in FIG. 1 and described herein).

At an operation 710, a vehicle event type may be determined based on information conveyed by the output signals. The determination of a vehicle event type may be responsive to the detection of a vehicle event. In some implementations, the vehicle event type may be determined based on visual output information that may be acquired from multiple video capture devices. The video capture devices may have individual corresponding fields of view. In some implementations, the vehicle event type may be determined based on the individual corresponding fields of view of the video capture devices. The vehicle event type may include more than one vehicle event types and/or one or more vehicle event subtypes. A vehicle event may have more than one vehicle event type. In some implementations, responsive to a review, by a manual reviewer, of the vehicle event and/or previous vehicle events of the same vehicle event type determined at operation 710, method 700 may include generating coaching session information that corresponds to the vehicle event for use in a coaching session.

At an operation 712, review criteria may be generated that correspond to the vehicle event. The review criteria may be based on the vehicle event type and the fields of view corresponding to the video capture devices. For example, review criteria generated for a rear view may be different that review criteria generated for a side view. In some implementations, the review criteria may be generated based on corresponding fields of view of non-system integrated video capture devices. Non-system integrated video capture devices may be located, for example, in the vehicle environment, on the vehicle, on other vehicles, and/or in other locations. In some implementations, operation 712 may be performed by a processor component the same as or similar to control component 110 (shown in FIG. 1 and described herein).

Returning to FIG. 1, operator interface 118 and/or reviewer interface 126 are configured to provide an interface between system 100 and users through which the users may provide information to and receive information from system 100. Users may include an operator, reviewer, and/or other user. This enables pre-determined profiles, criteria, data, cues, results, instructions, review criteria, and/or any other communicable items, collectively referred to as “information,” to be communicated between an operator and one or more of processor 102, sensors 112, video capture devices 114, vehicle 122, remote computing device 128, and/or other components of system 100.

In some embodiments, operator interface 118 and/or reviewer interface 126 may be included in remote computing device 128. Examples of interface devices suitable for facilitating an operator and/or reviewer interface 126 comprise a keypad, buttons, switches, a keyboard, knobs, levers, a display screen, a touch screen, speakers, a microphone, an indicator light, an audible alarm, a printer, a tactile feedback device, and/or other interface devices. In one implementation, remote computing device 128 comprises a plurality of separate interfaces. In one implementation, reviewer interface 126 comprises at least one interface that is provided integrally with processor 102 and/or electronic storage 120.

It is to be understood that other communication techniques, either hard-wired or wireless, are also contemplated by the present disclosure as operator interface 118 and/or reviewer interface 126 included in remote computing device 128. For example, the present disclosure contemplates that operator interface 118 and/or the reviewer interface 126 included in remote computing device 128 may be integrated with a cellular and/or wireless (Wi-Fi) connection. In some implementations, operator interface 118 and/or the reviewer interface 126 included in remote computing device 128, may be included in a removable storage interface provided by electronic storage 120 (although this implementation may not be as scalable as integration with a cellular and/or wireless connection). In these examples, information may be loaded into system 100 wirelessly from a remote location, from removable storage (e.g., a smart card, a flash drive, a removable disk, etc.), and/or other sources that enable the user(s) to customize the implementation of system 100. Other exemplary input devices and techniques adapted for use with system 100 as reviewer interface 126 and/or operator interface 118 comprise, but are not limited to, an RS-232 port, RF link, an IR link, modem (telephone, cable, and/or other modems), a cellular network, a Wi-Fi network, a local area network, and/or other devices and/or systems. In short, any technique for communicating information with system 100 is contemplated by the present disclosure as user interface 118 and/or the user interface included in remote computing device 128.

Electronic storage 120 may comprise electronic storage media that electronically stores information. The electronic storage media of electronic storage 120 may comprise one or both of system storage that is provided integrally (e.g., substantially non-removable) with system 100 and/or removable storage that is removably connectable to system 100 via, for example, a port (e.g., a USB port, a firewire port, etc.) or a drive (e.g., a disk drive, etc.). Electronic storage 120 may comprise one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 120 may store software algorithms, recorded video event data, information determined by processor 102, information received via operator interface 118, information received via reviewer interface 126, and/or other information that enables system 100 to function properly. Electronic storage 120 may be (in whole or in part) a separate component within system 100, or electronic storage 120 may be provided (in whole or in part) integrally with one or more other components of system 100.

Remote computing device 128 may include one or more processors, reviewer interface 126, operator interface 118, electronic storage, and/or other components. Remote computing device 128 may be configured to enable an operator and/or reviewer to interface with system 100 (e.g., as described above), and/or provide other functionality attributed herein to remote computing device 128. Remote computing device 128 may be configured to communicate with processor 102 via a network such as the internet, cellular network, Wi-Fi network, Ethernet, and other interconnected computer networks. Remote computing device 128 may facilitate viewing and/or analysis of the information conveyed by the output signals of sensors 112, the visual output information from video capture devices 114, the information determined by processor 102, the information stored by electronic storage 120, information from any external resources 116, and/or other information. By way of non-limiting example, remote computing device 128 may include one or more of a server, a server cluster, desktop computer, a laptop computer, a handheld computer, a tablet computing platform, a NetBook, a Smartphone, a gaming console, and/or other computing platforms.

In some implementations, remote computing device 128 may be and/or include a server. The server may include communication lines, or ports to enable the exchange of information with a network, processor 102 of system 100, and/or other computing platforms. The server may include a plurality of processors, electronic storage, hardware, software, and/or firmware components operating together to provide the functionality attributed herein to remote computing device 128. For example, the server may be implemented by a cloud of computing platforms operating together as a system server.

As described above, processor 102 may be configured to provide information processing capabilities in system 100. As such, processor 102 may comprise one or more of a digital processor, an analog processor, a digital circuit designed to process information, an analog circuit designed to process information, a state machine, and/or other mechanisms for electronically processing information. Although processor 102 is shown in FIG. 1 as a single entity, this is for illustrative purposes only. In some implementations, processor 102 may comprise a plurality of processing units. These processing units may be physically located within the same device (e.g., a vehicle event recorder), or processor 102 may represent processing functionality of a plurality of devices operating in coordination.

Processor 102 may be configured to execute components 104, 106, 108, and/or 110 by software; hardware; firmware; some combination of software, hardware, and/or firmware; and/or other mechanisms for configuring processing capabilities on processor 102. It should be appreciated that although components 104, 106, 108, and 110 are illustrated in FIG. 1 as being co-located within a single processing unit, in implementations in which processor 102 comprises multiple processing units, one or more of components 104, 106, 108, and/or 110 may be located remotely from the other components. The description of the functionality provided by the different components 104, 106, 108, and/or 110 described herein is for illustrative purposes, and is not intended to be limiting, as any of components 104, 106, 108, and/or 110 may provide more or less functionality than is described. For example, one or more of components 104, 106, 108, and/or 110 may be eliminated, and some or all of its functionality may be provided by other components 104, 106, 108, and/or 110. As another example, processor 102 may be configured to execute one or more additional components that may perform some or all of the functionality attributed below to one of components 104, 106, 108, and/or 110.

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system configured to detect vehicle events and present information regarding detected vehicle events, the system comprising:
multiple video capture devices, carried by a vehicle, and configured to capture visual output information representing a vehicle environment, wherein the vehicle environment includes spaces in an interior of the vehicle and outside of the vehicle;
one or more sensors configured to generate output signals conveying vehicle operation information related to operation of the vehicle, wherein the one or more sensors are carried by the vehicle; and
one or more physical computer processors configured by computer readable instructions to:
detect, by the one or more physical processors, a vehicle event based on the vehicle operation information conveyed by the output signals;
responsive to detection of the vehicle event, determine, by the one or more physical processors, a vehicle event type for the vehicle event based on the vehicle operation information, wherein determination of the vehicle event type for the vehicle event includes classifying the vehicle event into one or more of multiple vehicle event types, wherein the multiple vehicle event types include a rear vehicle event type, a front vehicle event type, a side vehicle event type, an interior vehicle event type, and an exterior vehicle event type;
generate, by the one or more physical processors, vehicle event information regarding the vehicle event, wherein the vehicle event information is based on the vehicle event type;
facilitate, by the one or more physical processors, electronic communication to a remote computing device of (i) part of the vehicle operation information that pertains to the vehicle event, (ii) part of the visual output information that pertains to the vehicle event, and (iii) the vehicle event information, wherein the remote computing device is remote and separate from the vehicle;
receive, from the remote computing device, by the one or more physical processors, reviewer information based on information provided by a reviewer subsequent to the electronic communication; and
generate a vehicle event record for the vehicle event, wherein the vehicle event record includes the reviewer information.

2. The system of claim 1, wherein the one or more physical computer processors are further configured to effectuate customization of a user interface presented by the remote computing device to the reviewer, wherein the customization is based on the vehicle event information.

3. The system of claim 2, wherein the information provided by the reviewer has been provided through the user interface.

4. The system of claim 1, wherein at least one of the multiple video capture devices is configured to acquire the visual output information from a left side or a right side of the vehicle.

5. The system of claim 2, further comprising the remote computing device, wherein the remote computing device includes one or more computer processors configured by computer readable instructions to:
present the user interface to the reviewer; and
customize the user interface based on the vehicle event information.

6. The system of claim 1, wherein the detection of the vehicle event is based on the vehicle operation information conveyed by the output signals that correspond to a set of parameters that describe the vehicle event.

7. The system of claim 1, wherein generation of the vehicle event information is further based on the visual output information.

8. The system of claim 1, wherein the one or more physical computer processors are further configured, responsive to analysis of the detected vehicle event and/or previous detected vehicle events, to generate coaching session information that corresponds to the detected vehicle event for use in a coaching session, wherein the coaching session information is different from the information provided by the reviewer.

9. The system of claim 1, wherein the one or more physical computer processors are further configured to generate a performance score for a vehicle operator of the vehicle at the time of the detected vehicle event, wherein the performance score is based on the information provided by the reviewer.

10. The system of claim 1, wherein a first part of the vehicle event information corresponds to a first portion of the visual output information that has been captured by a first video capture device, and wherein a second part of the vehicle event information corresponds to a second portion of the visual output information that has been captured by a second video capture device.

11. A method for detecting a vehicle event and presenting information regarding detected vehicle events, the method comprising:
capturing visual output information representing a vehicle environment of a vehicle from multiple video capture devices, wherein the vehicle environment includes spaces in an interior of the vehicle and outside of the vehicle;
generating output signals conveying vehicle operation information related to operation of the vehicle;
detecting a vehicle event based on the vehicle operation information conveyed by the output signals;
responsive to detection of the vehicle event, determining a vehicle event type for the vehicle event based on the vehicle operation information, wherein determination of the vehicle event type for the vehicle event includes classifying the vehicle event into one or more of multiple vehicle event types, wherein the multiple vehicle event types include a rear vehicle event type, a front vehicle event type, a side vehicle event type, an interior vehicle event type, and an exterior vehicle event type;
generating vehicle event information regarding the vehicle event, wherein the vehicle event information is based on the vehicle event type; and
facilitating electronic communication to a remote computing device of(i) part of the vehicle operation information that pertains to the vehicle event, (ii) part of the visual output information that pertains to the vehicle event, and (iii) the vehicle event information, wherein the remote computing device is remote and separate from the vehicle;
receiving, from the remote computing device, reviewer information based on information provided by a reviewer subsequent to the electronic communication; and
generating a vehicle event record for the vehicle event, wherein the vehicle event record includes the reviewer information.

12. The method of claim 11, further comprising:
effectuating customization of a user interface presented by the remote computing device to the reviewer, wherein the customization is based on the vehicle event information.

13. The method of claim 12, wherein the information provided by the reviewer has been provided through the user interface.

14. The method of claim 11, wherein at least one of the individual video capture devices is configured to acquire the visual output information from a left side or a right side of the vehicle.

15. The method of claim 12, further comprising:
presenting, at the remote computing device, the user interface to the reviewer; and
customizing the user interface based on the vehicle event information.

16. The method of claim 11, further comprising determining a set of parameters that describe the vehicle event, wherein the detection of the vehicle event is based on the set of parameters corresponding to the vehicle operation information conveyed by the output signals.

17. The method of claim 11, wherein generating the vehicle event information is further based on the visual output information.

18. The method of claim 11, further comprising, responsive to analysis of the detected vehicle event and/or previous detected vehicle events, generating coaching session information that corresponds to the detected vehicle event for use in a coaching session, wherein the coaching session information is different from the information provided by the reviewer.

19. The method of claim 11, further comprising:
generating a performance score for a vehicle operator of the vehicle at the time of the vehicle event, wherein the performance score is based on the information provided by the reviewer.

20. The method of claim 11, wherein a first part of the vehicle event information corresponds to a first portion of the visual output information that has been captured by a first video capture device, and wherein a second part of the vehicle event information corresponds to a second portion of the visual output information that has been captured by a second video capture device.
